(19) United States
(12) Patent Application Publication
(10) Pub. No.: US 2026/0036955 A1
(43) Pub. Date: Feb. 5, 2026

(54) EQUIPMENT MONITORING SYSTEM

(71) Applicant: Hussmann Corporation, Bridgeton, MO (US)

(72) Inventor: Ramakrishna Krishnaswamy, St. Charles, MO (US)

(21) Appl. No.: 19/476,821

(22) PCT Filed: Apr. 19, 2024
(86) PCT No.: PCT/US2024/025548

§ 371 Date: Oct. 20, 2025

Related U.S. Application Data
(60) Provisional application No. 63/497,365, filed on Apr. 20, 2023.

(51) Int. Cl. G05B 15/02; H04L 67/125; H04L 67/53; H04L 69/18

(52) U.S. Cl. CPC G05B 15/02; H04L 67/125; H04L 67/53; H04L 69/18

(57) ABSTRACT

Systems and methods for equipment communications by protocol recognition. One system includes a master system controller, a first unit controller associated with a first equipment, and an equipment control module communicatively coupled to the first unit controller and the master system controller. The equipment control module includes an electronic processor configured to receive data regarding the first equipment, identify a first communications protocol for communications from the first unit controller to the master system controller through the equipment control module, transmit the received data regarding the first equipment to the master system controller according to the first communications protocol, and transmit the received data regarding the first equipment to a third-party electronic system controller according to a second communications protocol.

### BACKGROUND

The present invention relates to an equipment monitoring system and, more particularly, to communication between multiple different equipment managers and equipment controllers.

Facilities (e.g., supermarkets, retail stores, etc.) may include refrigeration and/or heating, ventilation, and air conditioning (HVAC) systems and other equipment that generate data for use in managing the systems/equipment. Such systems/equipment may include different subsystems or components (e.g., heat exchangers, compressor systems, valve systems, condensers, etc.). Each equipment may include an electronic unit controller that may be configured to exchange information regarding the respective equipment (and/or one or more components thereof) with a centralized master system controller that is typically managed by the control manufacturer of the equipment or component.

In some systems, communications between the master system controller and the unit controllers are exchanged serially via a two-wire interface network (e.g., according to a serial peripheral (SPI) protocol, an inter-integrated circuit (I2C) protocol, a Modbus protocol, a BACnet protocol, etc.). In these systems, the main master system controller may be configured to exchange information with the respective unit controllers based on the respective communications protocol, but any other system/device may be unable to obtain or exchange information from a unit controller of the system. Furthermore, any modifications to equipment (e.g., adding a new component to the equipment) may be limited to the capabilities of the respective unit controller. Such modifications would thus require adjustments to the unit controller itself and/or installing one or more additional modules, which may be expensive and time-consuming.

### SUMMARY

In one aspect, an equipment monitoring system includes a master system controller, a first unit controller associated with a first equipment, and an equipment control module communicatively coupled to the unit controller and the master system controller. The equipment control module includes an electronic processor configured to receive data regarding the first equipment, identify a first communications protocol for communications from the first unit controller to the master system controller through the equipment control module, transmit the received data regarding the first equipment to the master system controller according to the first communications protocol, and transmit the received data regarding the first equipment to a third-party electronic communication device according to a second communications protocol.

In another aspect, a method for monitoring equipment includes receiving, at an equipment control module, data regarding a first equipment from a first unit controller, identifying a first communications protocol for communications from the first unit controller to a master system controller through the equipment control module, transmitting the received data regarding the first equipment to the master system controller according to the first communications protocol, and transmitting the received data regarding the first equipment to a third-party electronic communication device according to a second communications protocol.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate examples of concepts that include the claimed invention, and explain various principles and advantages of those examples.

FIG. 1 is a schematic diagram of an exemplary equipment monitoring system.

FIG. 2A is a schematic block diagram of an exemplary equipment control module of the system of FIG. 1.

FIG. 2B is a schematic block diagram of an exemplary input/output interface of the equipment control module of the system of FIG. 2A.

FIG. 3 is a schematic block diagram of a master system controller of the system of FIG. 1.

FIG. 4 is a schematic block diagram of a unit controller of the system of FIG. 1.

FIG. 5 is a schematic block diagram of an exemplary electronic system controller of the system of FIG. 1.

FIG. 6 is a flowchart illustrating a method for facilitating communications of the equipment maintenance system implemented by the equipment control module of FIG. 2.

FIG. 7 is a schematic diagram of another exemplary equipment monitoring system.

FIG. 8 is a schematic diagram of another exemplary equipment monitoring system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples of the present invention.

The apparatus and method components have been represented where appropriate by conventional symbols in the drawings, showing only those specific details that are pertinent to understanding the examples of the present invention so as not to obscure the disclosure with details that will be readily apparent to those of ordinary skill in the art having the benefit of the description herein.

### DETAILED DESCRIPTION

Before any examples of the invention are explained in detail, it is to be understood that the invention is not limited in its application to the details of construction and the arrangement of components set forth in the following description or illustrated in the following drawings. The invention is capable of other examples and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Terms of degree, such as “substantially” or “approximately” are understood by those of ordinary skill to refer to reasonable ranges outside of the given value, for example, general tolerances associated with manufacturing, assembly, and use of the described examples.

It should be noted that a plurality of hardware and software-based devices, as well as a plurality of different structural components may be utilized to implement the examples described herein or portions thereof. In addition, it should be understood that examples described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, the electronic based aspects described herein may be implemented in software (stored on non-transitory computer-readable medium) executable by one or more processors. As such, it should be noted that a plurality of hardware and software-based devices, as well as a plurality of different structural components may be used to implement the examples described herein. For example, “controller,” “control unit,” “control module,” and “control assembly” described in the specification may include one or more processors, one or more memory modules including non-transitory computer-readable medium, one or more input/output interfaces, and various connections (e.g., a system bus) connecting the components.

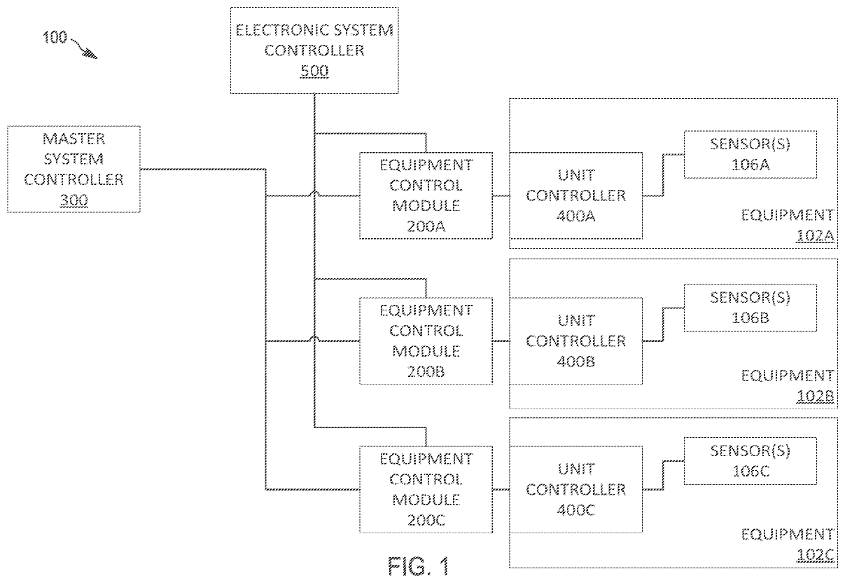

FIG. 1 is a schematic diagram of an exemplary equipment monitoring system 100 including a plurality of assets or equipment 102A, 102B, 102C (singularly referred to herein as equipment 102). The system 100 includes equipment control modules 200A, 200B, 200C (singularly referred to herein as equipment control module 200), a master system controller 300, unit controllers 400A, 400B, 400C (singularly referred to herein as unit controller 400), and an electronic system controller 500. As shown in one example, each unit controller 400A-400C is associated with a respective equipment 102A-102C. Additionally, each unit controller 400 is communicatively coupled to a respective equipment control module 200.

It will be appreciated that the system 100 may include any quantity of equipment 102 (e.g., fewer or more than the three illustrated exemplary equipment 102A-102C), any quantity of equipment control modules 200 (e.g., fewer or more than the three illustrated exemplary equipment control modules 200A-200C), and any quantity of unit controllers 400 (e.g., fewer or more than the three illustrated exemplary unit controllers 400A-400C) based on the desired design characteristics and parameters for the system 100.

The electronic system controller 500 (e.g., a third-party electronic controller device configured to manage or monitor, or both, one or more of the equipment 102 of the system 100) separate from the manufacturer's master system controller 300 through communications between the electronic system controller 500 and one or more of the equipment control modules 200A 200C. Each equipment control module 200 is distinct from the unit controller 400 of the equipment 102 and, as explained in more detail below, is configured to seamlessly (i.e. with little or no modification) provide data associated with a particular equipment 102 from a respective unit controller 400 to the master system controller 300. The equipment control module 200 may also be configured to provide similar data to the electronic system controller 500.

Each unit controller 400 is arranged and configured to monitor and operate one or more subsystems of the respective equipment 102 and to gather data associated with the equipment 102 via one or more respective sensors (for example, sensors 106A, 106B, and 106, which are singularly referred to herein as sensors 106). In non-limiting examples, the data may include one or more of self-identification data (e.g., information conveying the identity of the equipment 102, information conveying the location of the equipment 102, etc.) and operating conditions associated with the equipment 102. It will be appreciated that the data gathered by the unit controller 400 may be any type or kind of data associated with the equipment 102. The equipment 102 may include a refrigeration system (e.g., one or more types of refrigeration systems for merchandisers or display cases and associated equipment), a HVAC system, or a subcomponent/subsystem thereof (e.g., a compressor, a cooling subsystem, a heat or reheat subsystem, a valve, a valve subsystem or assembly, sub-controls, heat exchangers, etc.). With reference to FIGS. 1, 2, and 4, the equipment 102 may include one or more sensors or other detection devices (for example, the sensors 106) that detect or sense information about one or more characteristics of the equipment 102. As explained in more detail below, the information detected by the sensors 106 is received at the unit controller 400 and is transmitted from the unit controller 400 to the master system controller 300 through the equipment control module 200.

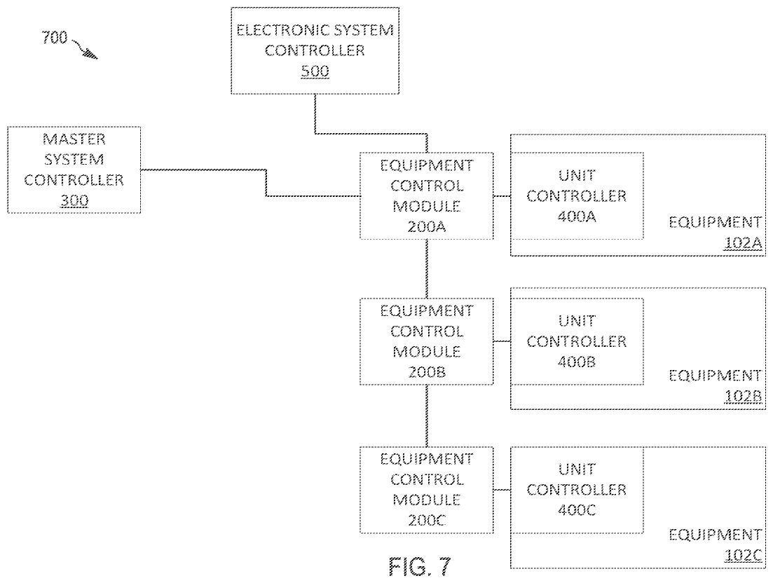

As shown in the example of FIG. 1, each unit controller 400 is directly communicatively coupled (i.e., no intermediary controllers between) to a respective equipment control module 200. For example, each unit controller 400 and respective equipment control module 200 may be communicatively coupled via a serial two-wire interface connection (e.g., according to an SPI, an I2C, a Modbus, a BACnet protocol, etc.). As shown, each of the equipment control modules 200A-200C is directly communicatively coupled to the master system controller 300 It will be appreciated that the equipment control modules 200A-200C may be located communicatively upstream of the master system controller 300 such that information and communications may be transmitted from the equipment control modules 200A-200C to the master system controller 300, or communications between the equipment control modules 200A-200C and the master system controller 300 may be bi-directional. In some examples, only a subset of the plurality of equipment control modules 200A-200C (e.g., a single equipment control module 200, or fewer than all equipment control modules 200A-200C) is/are directly connected to the master system controller 300. For example, and as explained in more detail below with regard to FIG. 7, the equipment control module 200A may be directly communicatively coupled to the master system controller 300 and the equipment control module 200B, while the equipment control module 200B may be directly communicatively coupled to the equipment control module 200C (i.e. a daisy-chain topology). In these examples, at least the communications protocol between the master system controller 300 and the equipment control module 200A that is directly communicatively coupled to the master system controller 300 is the same as the communications protocol(s) utilized between each of the equipment control modules 200A-200C and the respective unit controllers 400A-400C.

Communications between each of the equipment control modules 200A-200C and the master system controller 300 are performed according to the same communications protocol as the communications protocol between each control module 200A-200C and the respective unit controller 400. That is, each of the control modules 200A-200C may seamlessly (i.e. with minimal or no modification) exchange the same data (provided to and received from the unit controllers 400A-400C) with the master system controller 300 according to the same serial communications protocol as the protocol used directly between the respective unit controllers 400A-400C and the equipment control modules 200A-200C. In some examples, the only communication channel of the unit controller 400 is that between the unit controller 400 and the equipment control module 200.

With continued reference to FIG. 1, each equipment control module 200 is configured to exchange communications (e.g., data from the one or more sensors 106 and other information associated with the equipment 102 provided by the respective unit controller 400, instructions from the master system controller 300, etc.) with the electronic system controller 500. The communication links between of each of the equipment control modules 200 and the electronic system controller 500 may be wired (e.g., according to the same serial communications protocol that is used for communication between the master system controller 300 and the respective unit controller 400 through the equipment control module 200), implemented wirelessly (e.g., using a wide area network, such as the Internet, a Long Term Evolution (LTE) network, a Global System for Mobile Communications (or Groupe Spécial Mobile (GSM)) network, a Code Division Multiple Access (CDMA) network, an Evolution-Data Optimized (EV-DO) network, an Enhanced Data Rates for GSM Evolution (EDGE) network, a 3G network, a 4G network, a 5G network, a local area network, for example a Wi-Fi network, a personal area network, for example a Bluetooth network, and combinations or derivatives thereof), or a combination of wired and wireless connections. In some examples, the equipment control module 200 exchanges data with the electronic system controller 500 according to, for example, a second communications protocol, different from the serial communications protocol that is utilized for communication between the unit controller 400 and the master system controller 300 through the control module 200. Each of the equipment control modules 200A-200C (or, in some examples, a subset thereof) may communicate with the electronic system controller 500 according to the same or different wired and/or wireless communications protocols.

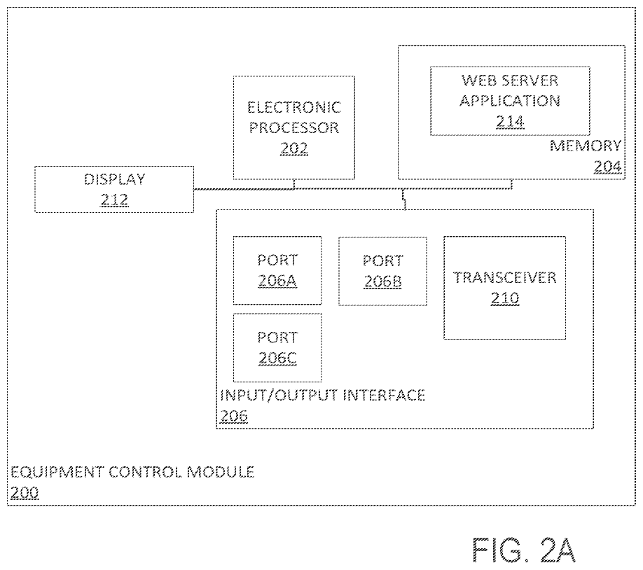

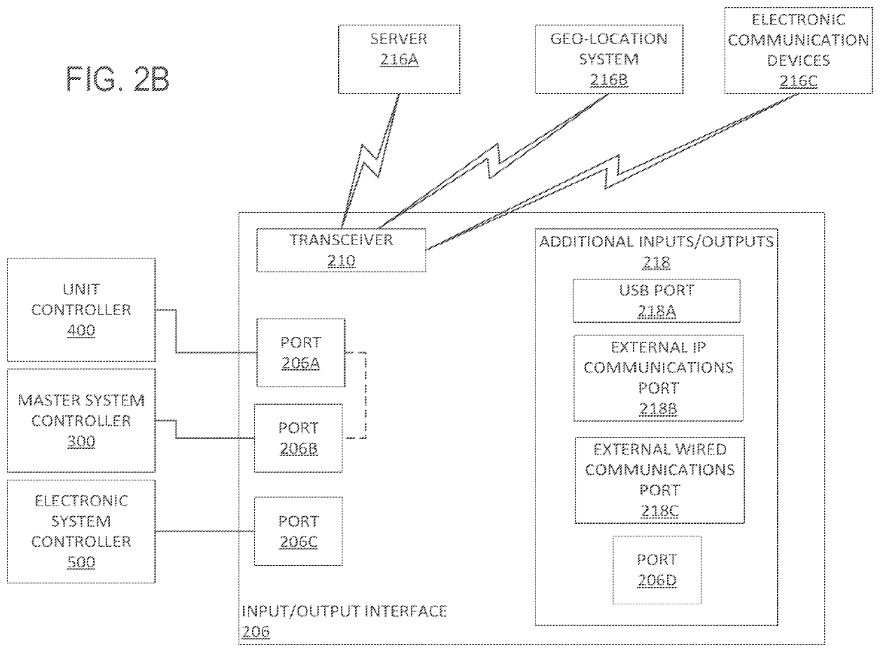

As explained in more detail below, the equipment control module 200 serves as an intermediary communications hub that is directly communicatively connected to the electronic system controller 500, the master system controller 300, and the respective unit controller(s) 400. The equipment control module 200 is configured to seamlessly forward/transmit the data received from the respective unit controller 400 (e.g., via the sensor(s) 106) to and from the master system controller 300, as well as forward/transmit the same (or similar) data to the electronic system controller 500. It will be appreciated that the data may be pulled by the master system controller 300 and the electronic system controller 500, pushed by the equipment control module 200, or a combination of pulling or pushing the data. As explained in more detail below in regard to FIGS. 2A and 2B, the equipment control module 200 may include additional input/output interfaces (e.g., one or more ports and/or one or more transceivers) to allow for or facilitate communications with devices/components added to the system 100 that may or may not be directly connected to either or both of the master system controller 300 and/or the unit controller 400 (e.g., additional electronic system controllers, devices, and/or sensors).

It should be understood that the system 100 is provided as an example and, in some examples, the system 100 may include additional components. For example, the system 100 may include more equipment 102, unit controllers 400, equipment control modules 200, electronic system controllers 500, and/or master system controllers 300, other equipment that produces data, or combinations thereof. Furthermore, the related methods described herein may be applied concurrently to more than one equipment control module 200, equipment 102, unit controller 400, and/or master system controller 300 in some examples. For example, a single equipment control module 200 may be directly communicatively coupled in serial communication with the master system controller 300 (and electronic system controller 500) and with more than one unit controller 400, and each unit controller 400 may be associated with one or more of the equipment 102.

FIG. 2A is an exemplary schematic block diagram of the equipment control module 200 including an electronic processor 202 (e.g., a microprocessor, application-specific integrated circuit (ASIC), or another suitable electronic device), a memory 204 (e.g., a non-transitory, computer-readable storage medium), and an input/output interface 206. The input/output interface 206 optionally includes a transceiver 210 to provide wireless communications to and from one or more components of the system 100 as explained in more detail below (e.g., components directly or indirectly in communication with either or both of the master system controller 300 and/or unit controllers 400A-400C in addition to the electronic system controller 500). In some examples, the equipment control module 200 further includes a display 212.

The equipment control module 200 includes electrical and electronic components that provide power, operation control, and protection to the components and modules within the equipment control module 200. The illustrated components, along with other various modules and components, are coupled to each other by or through one or more control or data buses that enable communication therebetween. The use of control and data buses for the interconnection between and exchange of information among the various modules and components would be apparent to a person skilled in the art in view of the description provided herein.

FIG. 2A illustrates one example of the control module 200. The equipment control module 200 may include fewer or additional components and may perform functions (including, for example, on-device datalogging, troubleshooting, etc.) other than those explicitly described herein.

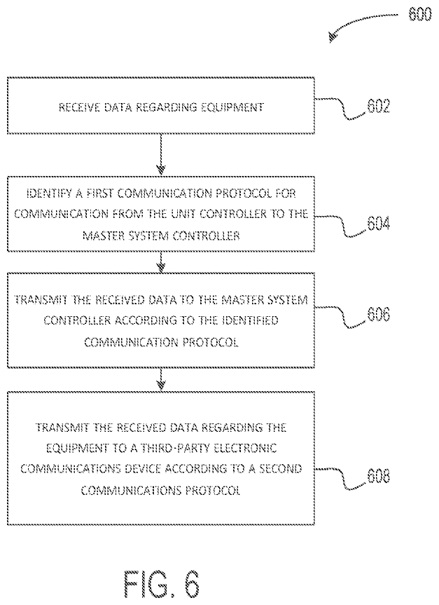

The memory 204 may include a program storage area and a data storage area. The processor 202 is connected to the memory 204 and executes computer readable instructions or code (“software”) stored in a random access memory (RAM) of the memory (e.g., during execution), a read only memory (ROM) of the memory (e.g., on a generally permanent basis), or another non-transitory computer readable medium. Software included for the processes and methods for identification and configuration of each electronic device can be stored in the storage memory 204. The software may include firmware, one or more applications, program data, filters, rules, one or more program modules, and/or other executable instructions. The processor 202 is configured to retrieve from the memory 204 and execute, among other things, instructions related to the processes and methods described herein (e.g., the method 600 of FIG. 6 described below). In some examples, some or all of the software and data stored in the memory 204 may also be stored in and retrieved from one or more databases (for example, the server 216A of FIG. 2B described below and/or within the electronic system controller 500) remote from the equipment control module 200.

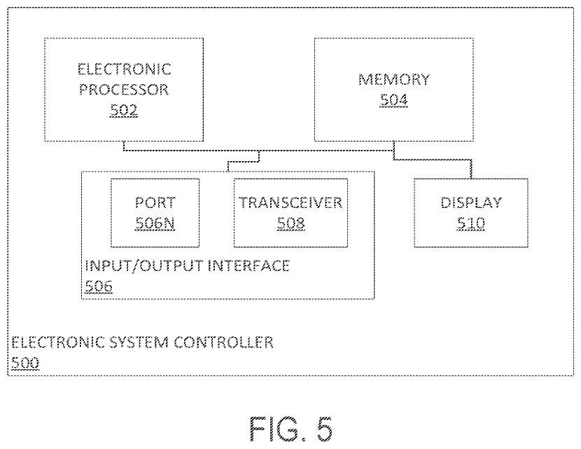

In some examples, the memory 204 stores a web service application 214 within the memory 204 which, when implemented by the electronic processor 202, may include one or more applications to provide information regarding one or more of the equipment 102A-102C based on the information received at the electronic system controller 500 from one or more of the equipment control modules 200A-200C (for example, the information associated with the equipment 102 as described above) to a user (for example, via a graphical user interface (GUI) of the display 212 described in more detail below). One or more services provided through the web service application 214 may be provided by a cloud services provider and may include third-party provided functions and applications. In some examples, some or all functions of the web service application 214 are stored at (for example, within a memory 504 with respect to FIG. 5 described in more detail below) and implemented by the electronic system controller 500.

In some examples, the application 214 of the equipment control module 200 may be part of a computing environment operable to provide users of the system 100 with the application 214 and other computing services (for example, via a GUI implemented at the display 212) implemented at least partially at the equipment control module 200. In some examples, the computing environment is operated for or by an enterprise and may securely provide, for example, applications for asset management and maintenance, location tracking, and the like. In some examples, the computing environment is operated by an enterprise to provide various business-related software applications and services to hundreds or thousands of employees in a secure manner. In some examples, some of all of the computing environment is operated for a contracting agency or enterprise by a service provider and contains dedicated software environments (for example, virtual servers), which are secured from one another and accessible only by their respective authorized groups of users. In some examples, the computing environment may include multiple software environments for serving tens, hundreds, or thousands of users across multiple agencies, enterprises, or both. In some examples, the computing environment includes components in multiple geographically distributed data centers.

The computing environment includes client computing devices, which access one or more of the application 214, provided by on one or more serving computing devices (for example, the equipment control module 200, in some examples). Users may alternatively or additionally access the application 214 (and other services of the computing environment) via client devices (for example, the electronic system controller 500, in some examples) from within the computing environment, from outside the computing environment (for example, using a VPN or other encrypted session), or both. Client computing devices include personal computers, portable communication devices (for example, a mobile phone or a tablet), or other electronic computing devices that can transmit and receive data to and from the computing environment. The computing environment may interconnect its computing devices via many different types of networks, such as, for example, those described above with respect to the transceiver 210 described below, to facilitate communication between the devices of the computing environment.

The input/output interface 206 is configured to receive input and to provide system output to and from the equipment control module 200. The input/output interface 206 obtains information and signals from, and provides information and signals to, (e.g., over one or more wired and/or wireless connections) devices both internal and external to the control module 200 (e.g., the unit controller 400, the master system controller 300, and/or the electronic system controller 500). Depending on the topology of the system 100, the unit controller 400 may be configured to exchange communications with at least one other unit controller 400 of the system 100. For example, the input/output interface 206 includes one or more ports for wired communications between the equipment control module 200 and the respective unit controller 400. Communications between the equipment control module 200 and the unit controller 400 may be exchanged according to a two-wire or two-way serial communications protocol. For example, the input/output interface 206 includes a communications port 206A for communicating with the unit controller 400 using serial communications, and a second communications port 206B for communicating with the master system controller 300 using serial communications (e.g., the same communications protocol used between the unit controller 400 and the equipment control module 200 via port 206A). The equipment control module 200 provides the information received from (and, in some examples, provided to) the unit controller 400 to and from the master system controller 300. The input/output interface 206 may include a third communications port 206C for communicating with the electronic system controller 500. In such examples, the port 206C is or may be utilized for parallel communications to and from the electronic system controller 500 (and, in further examples, one or more additional electronic system controllers). It should be understood that the input/output interface 206 may include additional ports for one or more additional inputs, outputs, or both.

In examples of the control module 200 (e.g., the input/output interface 206) including the transceiver 210, the transceiver 210 is adapted for communication with one or more communication links or communication networks used to communicate with other components or computing devices of the system 100 (e.g., the electronic system controller 500 and the master system controller 300). Stated another way, the control module 200 has multiple communication channels (e.g., dual communication channels, or more than two communication channels). For example, the transceiver 210 may be adapted for communication with one or more of the Internet (including public and private Internet Protocol (IP) networks), a Bluetooth network, a Wi-Fi network, for example operating in accordance with an Institute of Electrical and Electronics Engineers (IEEE) 802.11 standard (e.g., 802.11a, 802.11b, 802.11g, 802.11ax), a 3G standard network (including Global System for Mobiles (GSM) and Code Division Multiple Access (CDMA) standards), an LTE (Long-Term Evolution) network or other types of GSM networks, a 5G (including a network architecture compliant with, for example, the Third Generation Partnership Project (3GPP) Technical Specification (TS) 23 specification series and a new radio (NR) air interface compliant with the 3GPP TS 38 specification series) standard network, a Citizens Broadband Radio Service (CBRS), Worldwide Interoperability for Microwave Access (WiMAX) network, for example operating in accordance with an IEEE 802.16 standard, a Low Earth Orbit (LEO) network (e.g., for satellite phones or Internet connection), a Geosynchronous Orbit (GEO) network (e.g., for satellite phones), an Evolution-Data Optimized (EV-DO) network, an Enhanced Data Rates for Global Evolution (EDGE) network, or another similar type of wireless network. The transceiver 210 may include one or more wired transceivers, such as an Ethernet transceiver, a Universal Serial Bus (USB) transceiver, or similar transceiver configurable to communicate via a twisted pair wire, a coaxial cable, a fiber-optic link, or a similar physical connection to a wired network.

With continued reference to FIG. 2A, the input/output interface 206 receives information from one or more of the sensors 106. The sensor(s) 106 may be integrated into the equipment 102 of the unit controller 400 that is directly communicatively coupled to the equipment control module 200, the sensor(s) 106 may be separate from the equipment 102 and/or the unit controller 400, or a combination of both. The one or more sensors 106 include one or more types of sensors (e.g., image sensors, current sensors, pressure sensors, temperature sensors, flow sensors, humidity sensors, pressure sensors, vibration sensors, etc.) that collect related information regarding one or more characteristics of the equipment 102 (e.g., images of the equipment 102, pressure associated with a fluid of equipment 102, vibration associated with equipment 102 or a subcomponent thereof, a temperature (e.g., in a moment of time or over a period of time associated with the equipment 102 or a subcomponent thereof, etc.). The equipment control module 200 may receive information detected by the sensors 106 directly from the respective sensor(s) 106 (e.g., via one or more ports, or wirelessly via the transceiver 210), indirectly through the unit controller 400 and/or master system controller 300, or some combination thereof.

In some examples, the equipment control module 200 includes a display 212. The display 212 may be any suitable display for visually communicating information and, in some examples, two-way communication (e.g., a liquid crystal display (LCD) touch screen, an organic light-emitting diode (OLED) touch screen, etc.). In some examples, the equipment control module 200 implements a graphical user interface (GUI) (e.g., generated by the electronic processor 202, from instructions and data stored in the memory 204, such as data from the one or more sensors 208, and presented on the display 212), that enables a user to interact with the equipment control module 200. In some examples, the equipment control module 200 enables a display remotely. For example, the display 212 may be housed separate or away from the equipment control module 200. In another example, the equipment control module 200 may enable the display of another device such as a display of the electronic system controller 500.

The electronic processor 202, the memory 204, the input/output interface 206, the sensors 208, the transceiver 210, and the display 212 may include various digital and/or analog components, which are well known to one of ordinary skill in the art and for brevity are not described herein, and which may be implemented in hardware, software, or a combination of both. Some examples include separate transmitting and receiving components (e.g., a transmitter and a receiver), instead of the transceiver 210.

The electronic processor 202, the memory 204, the input/output interface 206, the sensors 208, the transceiver 210, the display 212 and other components of the control module 200 communicate over one or more communication lines or buses, or a combination thereof. As described in detail below, the control module 200 seamlessly forwards information associated with the respective equipment 102 (e.g., sensor data from one or more of the sensors 106) received from the unit controller 400 to the master system controller 300 according to a first serial communications protocol and to at least one other device (e.g., the electronic system controller 500) that is not directly communicatively coupled to the master system controller 300 or the unit controller 400. The electronic processor 202, in some examples, performs one or more on-device datalogging, troubleshooting functions, and the like based on the information received by the unit controller 400.

It should be understood that the equipment control module 200 may include additional components other than those illustrated in FIG. 2A in various configurations and may perform functionality in addition to or beyond the functionality described in the present application. Also, it should be understood that the functionality described herein as performed by the equipment control module 200 may be distributed among multiple devices, such as multiple servers and/or controllers (e.g., the electronic system controller 500), and may be provided through a cloud computing environment accessible by the equipment control module 200. For example, the equipment control module 200 may be configured to utilize a separate display (for instance, a display, which is not shown, of the electronic system controller 500, of the system controller 300, the respective unit controller 400, and/or of the equipment 102).

FIG. 2B is an exemplary schematic block diagram of the input/output interface 206 of the equipment control module 200. The illustrated block diagram includes various communication connections between the equipment control module 200 and systems and devices external from the equipment control module 200 through the input/output interface 206. It should be understood that all of the components of the input/output interface 206 illustrated in FIG. 2B are communicatively coupled to at least the electronic processor 202 of the equipment control module as shown in FIG. 2A.

As illustrated in FIG. 2B the equipment control module 200 includes ports 206A-206C. As described above, the unit controller 400 is directly communicatively coupled to the equipment control module 200 via the port 206A of the input/output interface 206. In the illustrated example, the port 206A provides information received at the port 206A seamlessly to the master system controller 300 through port 206B. In some examples, including the example shown in FIG. 2B, the port 206A may include a direct connection to the port 206B. In some examples, the port 206A provides the information to the port 206B through the electronic processor 202 (FIG. 2A). As also described above and illustrated in FIG. 2B, the port 206C is provided to exchange communications with the electronic system controller 500. In some examples, both the ports 206A and 206C are configured as master communication channel ports.

The transceiver 210 of the input/output interface 206, as described above, may comprise one or more transceivers for wireless communications with one or more components within or external to the system 100. In the example illustrated in FIG. 2B, the transceiver 210 may be configured to communicate with one or more of a server 216A. The server 216A may be a database server. The electronic processor 202 may be configured to store information regarding the equipment 102 (for example, data received from the unit controller 400) at the server 216A. In some examples, the server 216A is a web application server configured to provide one or more services and/or at least a portion of the computing environment of the web service application 214.

In some examples, the transceiver 210 is communicatively coupled to a geo-location system 216B. The geo-location system 216B is a system configured to identify a geographic location of the equipment control module 200. The geo-location system may be, for example, a global positioning system (GPS). The transceiver 210, in such examples, is configured to receive position information relating to the equipment 102 and/or the equipment control module 200.

In some examples, the transceiver 210 is configured to receive and/or transmit to and from one or more additional electronic communication devices. In the illustrated example, the transceiver is communicatively coupled to one or more electronic communication devices 216C (for example, via a Bluetooth network). Such electronic communication devices 216C may include one or more of a smartphone, a tablet computer, a laptop computer, a portable handheld communications device, and the like.

The input/output interface 206 may further include additional inputs/outputs 218 for wired communications. Such inputs/outputs 218 may include, but are not limited to, one or more of a USB port 218A, an external internet protocol (IP) communications port 218B, an external wired communications port 218C (for example, for two-wire 485 communications), and an additional port 206D for communications with one or more smart component systems (which are not shown). Such inputs/outputs 218 may be utilized for communications with one or more additional components internal to and/or external from the system 100, for example, to collect additional information associated with the equipment 102 and/or the system 100.

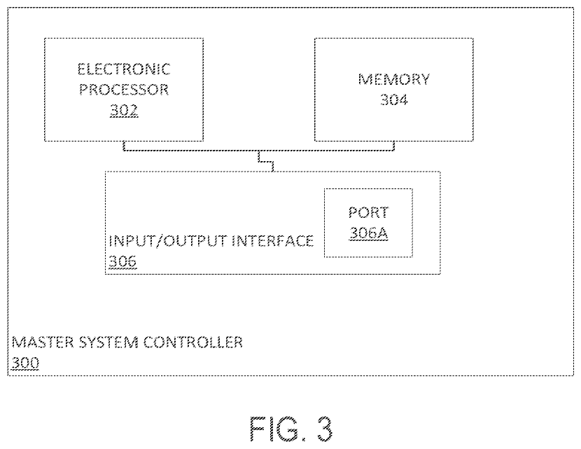

FIG. 3 is an exemplary schematic block diagram of the master system controller 300 including components that may be similar to some or all of the components of the control module 200 and/or the unit controller 400. For example, the master system controller 300 includes an electronic processor 302, a memory 304, and an input/output interface 306. The controller 300 is configured to monitor and facilitate operation(s) of each of the equipment 102, and/or one or more subsystems and components thereof, based on information received, via the input/output interface 306, from one or more respective unit controllers 400 through the equipment control module 200 (e.g., the equipment control module 200 acts a passthrough device for the controller 300). Also or in the alternative, the controller 300 may transmit commands to a respective unit controller 400 through the associated or corresponding equipment control module 200 (e.g., to control operation of the equipment 102 such as a heating or cooling operation of the equipment, a start/stop operation of the equipment, and other operational or functional aspects of the equipment 102, etc.). The input/output interface 306 includes at least one port 306A for serial communications between the master system controller 300 and at least one unit controller 400 through the associated equipment control module 200 (e.g., communications between a port 306A of the controller 300 and a port 206B of the equipment control module 200).

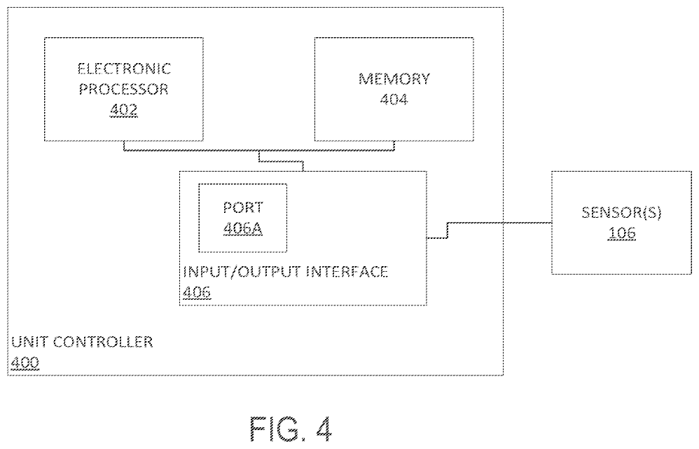

FIG. 4 is an exemplary schematic block diagram of the unit controller 400 including components that are similar to some or all of the components of the control module 200 and/or the master system controller 300. For example, the unit controller 400 includes an electronic processor 402, a memory 404, and an input/output interface 406. The input/output interface 406 includes at least one port 406A for serial communications exclusively between the unit controller 400 and the port 206A of the associated equipment control module 200 according to a particular communications protocol. The unit controller 400 is configured to monitor and/or facilitate operation(s) of the associated equipment 102 (and/or one or more subsystems/components thereof) based on information received, via the port 406A of the input/output interface 406, from the master system controller 300 through the equipment control module 200 via the port 206A.

It should be understood that either or both of the master system controller 300 and the unit controller 400 may include additional components other than those illustrated in FIG. 3 and FIG. 4, respectively, in various configurations, and may perform additional functionality beyond the functionality described in detail herein. For example, the master system controller 300 and/or the unit controller 400 may include a display (not shown) and/or utilize a display remote from the master system controller 300 and the unit controller 400. In some examples, the master system controller 300 may include a transceiver similar to the transceiver 210 described above with regard to FIG. 2. As another example, either or both of the master system controller 300 and the unit controller 400 may include one or more additional ports (e.g., for serial communications exclusively with another electronic component or controller of the system 100.

With reference to FIG. 1, the electronic system controller 500 is an electronic device capable of communicating with at least the equipment control module 200. The electronic system controller 500 may be, for example, a server. In some examples, the electronic system controller 500 is a portable communications device and may be, for example, a smart telephone, a smart watch, a laptop computer, a tablet computer, or other similar device capable of operating and functioning as described herein. In some instances, the electronic system controller 500 is or is part of a smart component system.

FIG. 5 is an exemplary schematic block diagram of the electronic system controller 500 including components that may be similar to some or all of the components of the control module 200, the master system controller 300, and/or the unit controller 400. The electronic system controller 500 includes components that are similar to the components described with regard to the control module 200, the master system controller 300, and/or the unit controller 400, including an electronic processor 502, a memory 504, and an input/output interface 506 with one or more ports 506N. In some examples, the electronic system controller 500 includes a transceiver 508 similar to the transceiver 210 described above with regard to FIG. 2. In some examples, the electronic system controller 500 includes a display 510 similar to the display 212 described above with regard to FIG. 2.

In some instances, the electronic processor 502 uses one or more machine learning methods to analyze information from the unit controller 400 (for example, information received from one or more of the other equipment control modules 200) to identify and predict one or more characteristics of at least one of the equipment 102. For example, the electronic processor 502 may identify a location of a particular equipment 102, identify or predict a malfunction of an equipment 102, and the like. Such methods may be performed as part of the web service application 214.

Machine learning generally refers to the ability of a computer program to learn without being explicitly programmed. In some instances, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, edge computing, inductive logic programming, support vector machines, clustering, Bayesian networks, reinforcement learning, representation learning, similarity and metric learning, sparse dictionary learning, and genetic algorithms. Using these approaches, a computer program can ingest, parse, and understand data and progressively refine algorithms for data analytics.

In some examples, the electronic processor 502 is configured to predict and/or identify a failure of one or more of the equipment 102 based on the received information associated with the equipment 102 using one or more machine learning methods. In some examples, the electronic processor 502 may identify a location (for example, a particular facility including one or more of the equipment 102) where a common failure is occurring based on the received information. The electronic processor 202 may further be configured to alert a user regarding the predicted failure and/or the location thereof (for example, via the display 212 or a notification provided at the electronic system controller 500). In some examples, the electronic processor 502 may be configured to generate a parts order or a repair request based on the determined failure.

It should be understood that the electronic system controller 500 may include additional components other than those illustrated in FIG. 5 in various configurations and may perform additional functionality beyond the functionality described in detail herein. For example, the electronic system controller 500 may include a display (for example, the display 510) and/or utilize a display remote from the electronic system controller 500. As another example, the electronic system controller 500 may include one or more additional ports (e.g., for serial communications exclusively with another electronic component or controller of the system 100). As another example, the electronic processor 502 is further configured to receive telemetry information regarding the equipment 102 via the input/output interface 506 in addition to the information regarding the equipment 102 received at the port(s) 506N. The telemetry information may include, for example, a serial number, a model number, an identifier, or some combination thereof, of a particular equipment 102. In some examples, at least a portion of the functionality of the electronic system controller 500 is performed at the equipment control module 200. The electronic system controller 500 may be configured to receive information from a two-dimensional or three-dimensional barcode (for example, from a barcode scanner communicatively coupled to the electronic system controller 500, which is not shown).

FIG. 6 illustrates an exemplary method 600 for facilitating communications and operation of an equipment maintenance system (e.g., the system 100). Although the method 600 is described in conjunction with the system 100 and equipment maintenance as described herein, the method 600 may be used with other systems and devices and for other purposes (e.g., control of and monitoring the equipment 102). In addition, it will be appreciated that the method 600 may be modified or performed differently than the specific example while still falling within scope of the invention described and illustrated herein.

As an example, the method 600 shown in FIG. 6 is performed by a single equipment control module 200 and, in particular, the electronic processor 202. However, it should be understood that in some examples, portions of the method 600 may be performed by additional electronic processors included in the equipment control module 200. For ease of description, the method 600 is described in terms of a single equipment control module 200 (e.g., equipment control module 200A), an associated unit controller 400 (e.g., unit controller 400A), and one of the equipment 102 (e.g., the equipment 102A). It should be understood that the method 600 may be applied to systems including multiple unit controllers 400 and equipment 102.

At block 602, the electronic processor 202 of the equipment control module 200 receives data associated with the equipment 102. The processor 202 receives data, via the port 206A, from the associated unit controller 400 of the equipment 102 (e.g., data from one or more of the sensors 106 of the equipment 102) or data, via port 206B, from the master system controller 300 (e.g., a command for affecting an operation of the unit controller 400 and/or the equipment 102). At block 604, the electronic processor 202 identifies a communications protocol for communications between the master system controller 300 and the unit controller 400 through the equipment control module 200. The electronic processor 202 is configured to automatically recognize or identify the communications protocol utilized by the master system controller 300 and at least one of the unit controllers 400 of the system 100 for communications therebetween based on at least one communication transmission received, by the electronic processor 202, from either of the master system controller 300 or the unit controller 400. For example, the identified communications protocol for communications between the master system controller 300 and the unit controller 400 is the same communications protocol used for communications between the port 406A of the unit controller 400 and the port 206A of the equipment control module 200 (e.g., a serial communications protocol). At block 606, the electronic processor 202 transmits the received data regarding the equipment 102 (e.g., via port 206B) to the master system controller 300 (e.g., via the port 306A) according to the identified communications protocol utilized by both the master system controller 300 and the unit controller 400 for communications between each other. At block 608, the electronic processor 202 transmits the received data regarding the equipment 102 to a third-party electronic communication device (for example, the electronic system controller 500) via, for example, the transceiver 210 or an additional port, such as port 206C).

The electronic processor 202, by transmitting the data to the master system controller 300 from the unit controller 400 according to the identified communications protocol, allows for seamless transmission of communications between the system controller 300 and the unit controller 400 through the equipment control module 200 while additionally providing information to the electronic system controller 500. In some examples, the electronic processor 202 transmits the data to the electronic system controller 500 according to a second communications protocol (e.g., a wireless communications protocol such as Bluetooth, Wi-fi, Internet, etc.) or a serial or parallel wired communications protocol. The electronic processor 202 may transmit the data regarding the equipment 102 according to a first communications protocol to the master system controller 300 and according to a second communications protocol to the equipment control module 200 in parallel (or at least approximately simultaneously to each other). The second communications protocol may be the same protocol as the first communications protocol or a different communications protocol.

In some examples, the electronic processor 202 is configured to receive, from the master system controller 300 and/or the electronic system controller 500, one or more commands regarding an operation of the associated unit controller 400 (e.g., to adjust an operation of the equipment 102 or a request for information regarding the equipment 102). The electronic processor 202 may then transmit the command to the unit controller 400 according to the communications protocol of block 604. In some embodiments, the electronic processor 202 is configured to perform a mitigation action based on the received data regarding the equipment 102, as described in more detail below.

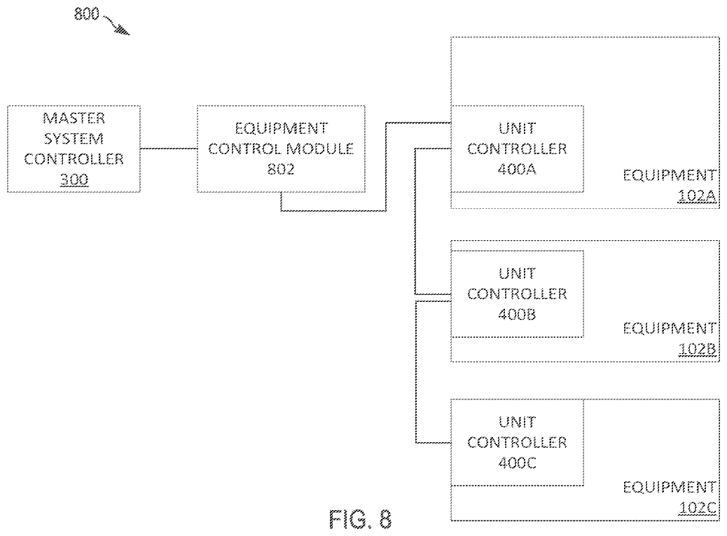

As described in more detail below, in some embodiments, the equipment control module 200 and the electronic system controller 500 may be incorporated into the same device (for example, electronic system controller 802 of FIG. 8, described in more detail below). In some embodiments, the received data regarding the equipment, at block 608 of the method 600, is additionally or alternatively transmitted to another electronic communications system/device (for example, any one of the server 216A, the geo-location system 216B, the electronic communication device(s) 216C, or some combination thereof).

As described with regard to FIG. 1, the topology of the system 100 (e.g., the serial communication links between the master system controller 300 and the respective pairs of the equipment control modules 200A-200C and the unit controllers 400A-400C) may vary based on design of the system 100. For example, FIG. 7 illustrates a schematic diagram of another exemplary equipment maintenance system 700. As shown, the system 700 includes the electronic system controller 500, the master system controller 300, and the respective pairs of the equipment control modules 200A-200C and the unit controllers 400A-400C. In this example, only the equipment control module 200A is directly communicatively coupled to the master system controller 300. The equipment control module 200A is further directly communicatively coupled to the equipment control module 200B and the equipment control module 200B is directly communicatively coupled to the equipment control module 200C. In such examples, at least the communications protocol between the system controller 300 and the equipment control module 200A directly communicatively coupled to the controller 300 is the same as the communications protocol(s) utilized between each of the equipment control modules 200A-200C and the respective unit controller 400A-400C. The equipment control module 200A may facilitate communications between the master system controller 300 and the unit controller 400B and 400C through the other respective equipment control modules 200B and 200C of the system 100 in addition to communications between the unit controller 400A and the master system controller 300. For example, the equipment control module 200A may include an additional port to exchange serial communications directly with the equipment control module 200B. The equipment control module 200B may, in turn, communicate with the equipment control module 200C via a serial communications port (e.g., the ports 206B of each module 200B and 200C). In some examples, and as illustrated in FIG. 7, communications between the equipment control modules 200A-200C are according to the same communications protocol (e.g., a serial communications protocol) as the communications protocol utilized for communications between the equipment control modules 200A-200C and the respective unit controllers 400A-400C. Although only the equipment control module 200A is in serial communication with the master system controller 300 in the example of FIG. 7, it should be understood that any number of the equipment control modules 200A-200C may be configured to communicate, according to the same serial communications protocol for communications to the master system controller 300 and/or the respective unit controller 400 or a different wired/wireless communications protocol such as those described above, with the electronic system controller 500.

As described herein, the control module 200 facilitates communication to different controllers by identifying and using one or more protocols that are consistent with the protocol(s) of the controllers with which the control module 200 is connected. That is, the control module 200 provides communication passthrough of information associated with the equipment 102 and other data, as well as instructions and other control and requests, from the electronic system controller 500 and master system controller 300. In this manner, the control module 200 may provide information, control signals, and other data to different master or system controllers in a bifurcated way so that different entities (e.g., a manager or other personnel of a first entity having access to the electronic system controller 500, and a manager or other personnel of a second, different entity having access to the master system controller 300) may receive the same information at or approximately at the same time. The control module 200 duplicates the protocol applicable to the master system controller 300 so that the second entity does not see any difference in data or control instructions transmitted between the master system controller 300 and the equipment 102.

The control module 200 has two master communication channels that enable duplicative passthrough communications. For example, a first master communication channel enables passthrough communication, via a first port (e.g., a unit controller communication port such as the port 206A of FIGS. 2A and 2B), with the unit controller 400. A second master communication channel enables passthrough communications and connection, via a second port (e.g., an asset communication port such as the port 206D of FIG. 2B), to one or more additional systems such as smart components or equipment (for example, the electronic system controller 500). In some examples, the second master communication channel may have additional ports to facilitate expansion and connection to additional or other assets or equipment, or to a secondary system. Such additional ports may enable additional inputs to or outputs from the equipment 102 (e.g., additional data points for equipment monitoring or control, updates to the equipment 102, etc.).

FIG. 8 illustrates a schematic diagram of another exemplary equipment maintenance system 800. As shown, the system 800 includes an equipment control module 802, the master system controller 300, and the respective unit controllers 400A-400C of equipment 102A-102C. The equipment control module 802 performs functionality similar to both the equipment control modules 200A-200C and the electronic system controller 500 described above. For example, equipment control module 802 is directly communicatively coupled to both the master system controller 300 and at least one of the unit controllers 400A-400C (in the illustrated example, unit controller 400A). The equipment control module 802 is configured to receive information about at least one of the equipment 102A-102C from at least one of the unit controllers 400A-400C (for example, unit controller 400A) and seamlessly provide the received data to the master system controller 300. The equipment control module 802 may be configured to evaluate the data regarding an equipment 102 received from a unit controller 400 and perform one or more operations based on the received data. The equipment control module 802 may be further communicatively coupled to one or more additional systems and or devices (for example, the server 216A, the geo-location system 216B, and one or more electronic communication devices 216C described above with respect to FIG. 2B) and performs one or more operations similar to those described above with respect to the equipment control module 200.

The communications protocol between the system controller 300 and the equipment control module 802 is the same as the communications protocol(s) utilized for communications between, for example, the unit controller 400A and the equipment control module 802 or at least two of the unit controllers 400A-400C. The communications protocol utilized by each of the unit controllers 400A-400C is the same as the communications protocol utilized for communications between the equipment control module 802 and the unit controller 400A. In some examples, the communications protocol utilized between the equipment control module 802 and the unit controller 400A is or may be different than the communications protocol utilized by each of the unit controllers 400A-400C.

The equipment control module 802 facilitates communications between the master system controller 300 and at least the unit controller 400A. It should be understood that, although the unit controllers 400A-400C and the equipment control module 802 are illustrated in a daisy-chain topology (i.e. the unit controller 400C is directly communicatively coupled to unit controller 400B, the unit controller 400B is directly communicatively coupled to unit controller 400A, and the unit controller 400A is directly communicatively coupled to the equipment control module 802), one or more of the unit controllers 400B and 400C may be communicatively coupled directly to the equipment control module 802. The equipment control module 802 may include one or more additional ports (for example, in addition to port 206C of FIG. 5) to exchange serial communications with a respective unit controller 400B and/or 400C directly.

The equipment control module 802 may provide and receive information similar to that received by the equipment control module 200 described above with respect to FIG. 2A and 2B. The equipment control module 802 receives information regarding one or more of the equipment 102A-102C (for example, real time equipment information such as measurement, operation, and performance data) as generally described above from the unit controller 400A (and/or unit controllers 400B and 400C). As described above, the equipment control module 802 may be communicatively coupled to one or more additional systems and/or devices. The equipment control module 802 may be configured to receive information regarding one or more of the equipment 102A-102C (for example, from server 216A, the geo-location system 216B, and/or the electronic communication devices 216C). The server 216A may be further configured to collect additional information regarding a particular equipment 102 (for example, warranty information, manufacturing information, engineering data, and the like)

The electronic system controller 500 is configured to provide information regarding one or more of the equipment 102A-102C (for example, real time equipment information such as measurement, operation, and performance data) as generally described above from the unit controller 400A (and/or unit controllers 400B and 400C). The electronic system controller 500 may also be configured to receive information regarding one or more of the equipment 102A-102C. The server 216A may be further configured to collect additional information regarding a particular equipment 102 (for example, warranty information, manufacturing information, engineering data, and the like). The equipment control module 802 of FIG. 8 is configured to perform similar functionality as that of the electronic system controller 500 in some examples of the system.

The illustrated electronic system controller 500 is configured as a gateway that connects the system 100 to one or more additional networks (for example, including the server 216A). The electronic system controller 500 may be an Internet of Things (IOT) gateway computer configured to register and perform on-boarding of one or more of the equipment 102A-102C. The equipment control module 802 of FIG. 8 is configured to perform similar functionality to that of the electronic system controller 500 in some examples of the system.

Based on the information regarding the equipment 102, the electronic system controller 500 (and, likewise, the electronic system controller 802) may be configured to perform a mitigation action. The mitigation action includes, but is not limited to, generating an alert to a user regarding a status of at least one of the equipment 102A-102C. The status may be an operational status of the equipment 102, a detected or predicted (via one or more machine learning functions as described above) malfunction of the equipment 102 (or of a component thereof), a location of the equipment 102, and the like. The alert may be generated, for example, on one or more of the display 212 of the equipment control module 200, the display 510 of the electronic system controller 500, and a display of one or more of the electronic communication devices 216C. The alert may be generated, for example, as part of the web server application 214.

The mitigation action may be a command to at least one of the equipment 102A-102C to adjust an operation of one or more of the equipment 102, the unit controller 400, the master system controller 300, or some combination thereof. The command may be, for example, to generate an alert, to change to a low power or sleep mode, to increase or decrease an output temperature (e.g., where the equipment 102 is a refrigeration system or an HVAC system), or to output an alert at the equipment 102 (e.g., generate an audio or visual warning). The command may be transmitted directly to the respective unit controller 400, or the command may be transmitted to the master system controller 300.

The mitigation action may include updating a status of a respective equipment 102 (for example, a status of the equipment 102 stored at a database, for example, at the electronic system controller 500 or another system/device, such as the server 216A) based on the received information. The mitigation action may include generating a parts order for one or more replacement parts for one or more of the equipment 102.

In the foregoing specification, specific examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting example the term is defined to be within 10%, in another example within 5%, in another example within 1%, and in another example within 0.5%. The term “coupled” as used herein is defined as connected, although not necessarily directly and not necessarily mechanically. A device or structure that is “configured” in a certain way is configured in at least that way, and may also be configured in ways that are not listed.

It will be appreciated that some examples may be comprised of one or more generic or specialized processors (or “processing devices”) such as microprocessors, digital signal processors, customized processors and field programmable gate arrays (FPGAs) and unique stored program or computer-readable instructions (including both software and firmware) that control the one or more processors to implement, in conjunction with certain non-processor circuits, some, most, or all of the functions of the method and/or apparatus described herein. Some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, aspects the system 100 can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various features and advantages of the invention are set forth in the following claims.

1. An equipment monitoring system comprising:
a master system controller;
a first unit controller associated with a first equipment; and
an equipment control module communicatively coupled to the first unit controller and the master system controller, the equipment control module including a storage medium, computer-readable instructions, and an electronic processor configured to execute the instructions to:
receive data regarding the first equipment,
identify a first communications protocol for communications from the first unit controller to the master system controller through the equipment control module,
transmit the received data regarding the first equipment to the master system controller according to the first communications protocol, and
transmit the received data regarding the first equipment to a third-party electronic communication device according to a second communications protocol.

2. The system of claim 1, wherein the electronic processor is further configured to receive, from either the master system controller or the third-party electronic communication device, a command regarding an operation of the first unit controller, and transmit, to the first unit controller, the command according to the first communications protocol.

3. The system of claim 1, wherein the electronic processor transmits the received data regarding the first equipment via the first communication protocol and the second communication protocol in parallel to each other.

4. The system of claim 1, wherein the electronic processor is configured to identify the first communications protocol based on a received data communication from the master system controller.

5. The system of claim 1, wherein the third-party electronic system controller is not in direct communication with the master system controller and the first unit controller.

6. The system of claim 1, wherein the first communications protocol includes a serial communications protocol.

7. The system of claim 1, wherein the electronic processor transmits the received data regarding the first equipment to the third-party electronic communications device according to a second communications protocol.

8. The system of claim 7, wherein the system includes a second unit controller associated with a second equipment, and wherein the electronic processor is further configured to:
receive, from the second unit controller, data regarding the second equipment,
transmit the received data regarding the second equipment to the master system controller according to the first communications protocol, and
transmit the received data regarding the second equipment to the third-party electronic communication device according to the second communications protocol.

9. The system of claim 1, wherein the system is further configured to perform a mitigation action based on the received data.

10. The system of claim 1, wherein the third-party electronic communication device is a third-party electronic system controller.

11. A method for monitoring equipment, the method comprising:
receiving, at an equipment control module, data regarding a first equipment from a first unit controller,
identifying a first communications protocol for communications between the first unit controller and a master system controller through the equipment control module,
transmitting the data regarding the first equipment to the master system controller according to the first communications protocol, and
transmitting the received data regarding the first equipment to a third-party electronic communication device according to a second communications protocol.

12. The method of claim 11, the method further comprising receiving, from either the master system controller or the third-party electronic communication device, a command regarding an operation of the first unit controller, and transmit, to the first unit controller, the command according to the first communications protocol.

13. The method of claim 11, wherein the equipment control module transmits the received data regarding the first equipment via the first communication protocol and the second communication protocol in parallel to each other.

14. The method of claim 11, wherein the equipment control module identifies the first communications protocol based on a received data communication from the master system controller

15. The method of claim 11, wherein the third-party electronic system controller is not in direct communication with the master system controller and the first unit controller.

16. The method of claim 11, wherein the first communications protocol includes a serial communications protocol.

17. The method of claim 11, wherein the equipment control module transmits the received data regarding the first equipment to the third-party electronic system controller according to a second communications protocol.

18. The method of claim 17, wherein the method further comprising:
receiving, from a second unit controller, data regarding the second equipment,
transmitting the received data regarding the second equipment to the master system controller according to the first communications protocol, and
transmitting the received data regarding the second equipment to the third-party electronic communication device according to the second communications protocol.

19. The method of claim 11, the method further comprising performing a mitigation action based on the received data.

20. The method of claim 11, wherein the third-party electronic communication device includes a third-party electronic system controller.
